(19) United States
(12) Patent Application Publication
(10) Pub. No.: US 2008/0092419 A1
(43) Pub. Date: Apr. 24, 2008

(54) CUSTOMIZABLE CARD BUTTON AND METHOD OF ADVERTISING SUCH

(76) Inventor: Lowell Muramoto, Modesto, CA (US)

Correspondence Address: WEISS & MOY PC, 4204 NORTH BROWN AVENUE, SCOTTSDALE, AZ, 85251, US

(21) Appl. No.: 11/465,714

(22) Filed: Aug. 18, 2006

(51) Int. Cl. G09F 3/00

(52) U.S. Cl. 40/315

(57) ABSTRACT

A customizable poker button for use as a marker in a poker game and having advertising indicia displayed thereon so that poker players and bystanders are capable of viewing the advertising indicia during a poker game. A pedestal is also provided for mounting the poker button thereon in order to allow the advertising indicia to be displayed substantially perpendicular to a table surface when a bottom surface of the pedestal is resting on a poker table.

### FIELD OF THE INVENTION

This invention relates generally to card games and accessories therefor and, more particularly, to a customizable card button and method of advertising such.

### BACKGROUND OF THE INVENTION

The card game of poker, with its many variations, is extremely popular. Poker is a common social pastime for both gamblers and non-gamblers. The most popular form of poker is Texas Hold'em, which involves dealing two cards to each player followed by dealing a series of community cards. The game of Omaha, is similar to Texas Hold'em, differing only in the quantity of cards dealt to each individual (4 are dealt in Omaha as compared to only 2 in Texas Hold'em). In both Texas Hold'em and Omaha the dealer position is coveted since it is strategically advantageous to be the last to commit money to the pot. For this reason, the dealer position is rotated clockwise after each hand so that each player receives this benefit.

In order for all players to be aware of the location of the dealer position, a large chip, known as “the button” identifies the location of the dealer position. In comparison to a standard poker chip, typically the dealer button is: 1) larger in diameter; 2) thicker; 3) heavier in weight; and 4) commonly engraved or otherwise marked with the word “Dealer.”

Despite these differences, many poker players have difficulty spotting the dealer button among the playing cards, poker chips, card weights and other objects located on a poker table. As poker continues to grow in popularity, advertising has become a major aspect of the poker industry. Nevertheless, the dealer button, which is viewed by all poker players, lacks any advertising indicia.

A need therefore existed for providing a customizable dealer button having advertising indicia and being more visible to poker players.

### SUMMARY OF THE INVENTION

An object of the present invention is to provide a customizable dealer button having advertising indicia.

It is a further object of the present invention to provide a dealer button mounted on a pedestal in order to be more visible to poker players.

### BRIEF DESCRIPTION OF THE PREFERRED EMBODIMENTS

In accordance with one embodiment of the present invention, a poker button is disclosed, comprising, in combination, a button having a front surface and a back surface, advertising indicia located on at least one of the front surface and the back surface of the button, and a substantially flat pedestal having a bottom surface and a top surface, the top surface of the pedestal coupled substantially perpendicular to the button so that the button being substantially perpendicular to a plane of a table when the bottom surface of the pedestal resting on the table.

In accordance with another embodiment of the present invention, a method of advertising is disclosed, comprising, in combination the steps of providing a poker button for use as a marker in a poker game, the poker button having a front surface and a back surface, and marking the button with advertising indicia on at least one of the front surface and the back surface of the button so that poker players are capable of viewing the advertising indicia when playing a poker game.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of a customized dealer button of the present invention, showing dealer indicia surrounding an area where advertising text can be placed.

FIG. 1A is a perspective view of the customized dealer button of FIG. 1, showing a substantially translucent button having dealer indicia surrounding an area where an advertising logo can be placed.

FIG. 2 is a perspective view of the customized dealer button of FIG. 1, showing an area where advertising text can be placed.

FIG. 3 is a perspective view of the customized dealer button of FIG. 1, showing an area where an advertising logo can be placed.

FIG. 4 is a perspective view of another embodiment of the customized dealer button of the present invention, showing a spinner having an area where advertising text can be placed.

FIG. 5 is a perspective view of the customized dealer button of FIG. 4, showing a spinner having an area where an advertising logo can be placed.

FIG. 6 is a perspective view of another embodiment of the customized dealer button of the present invention, showing a dealer button mounted on a pedestal and having an area where advertising text can be placed.

FIG. 6A is a perspective view of the customized dealer button of FIG. 6, showing a substantially translucent dealer button mounted on a pedestal and having an area where an advertising logo can be placed.

FIG. 7 is a perspective view of the customized dealer button of FIG. 6A, showing a dealer button mounted on a pedestal with the sample logo of dice being displayed.

FIG. 8 is a perspective view of the customized dealer button of FIG. 6A, showing a dealer button mounted on a pedestal with the sample logo of playing cards being displayed.

FIG. 9 is a perspective view of the customized dealer button of FIG. 6A, showing a dealer button mounted on a pedestal and showing dealer indicia surrounding an area where advertising text can be placed.

FIG. 10 is a perspective view of another embodiment of the customized dealer button of the present invention, showing a card place holder having an area where advertising text can be placed.

### DETAILED DESCRIPTION OF THE PREFERRED EMBODIMENTS

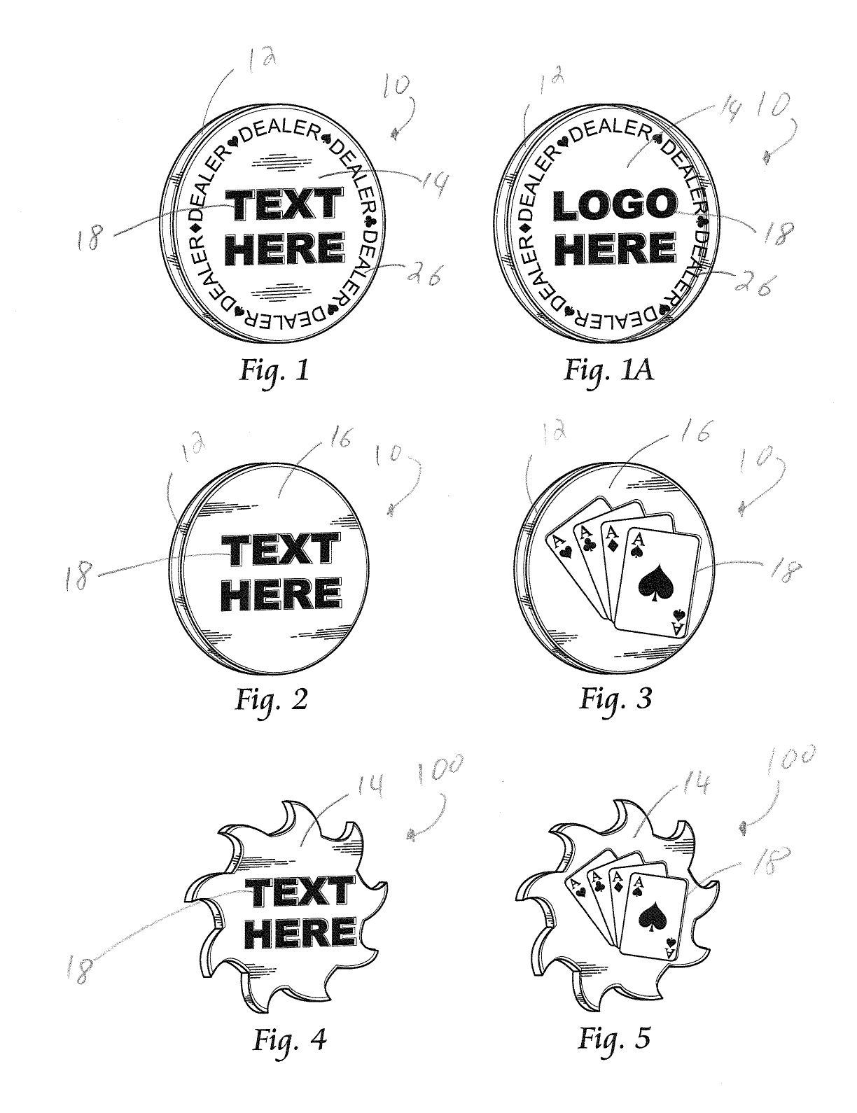

Referring now to FIGS. 1-3, a first embodiment of a poker button, hereinafter poker button 10, is disclosed. The poker button 10 of the present invention comprises a button 12 having a front surface 14 (shown in FIGS. 1 and 1A) and a back surface 16 (shown in FIGS. 2-3). Advertising indicia 18 is located on at lease one of the front surface 14 and the back surface 16 of the button 12. Advertising indicia 18, which could be the name of a casino, product or service, could either be used as a replacement to the standard “Dealer” label, or in addition to it (with the “Dealer” inscription being placed along a periphery of the button 12 as shown, for example, in FIGS. 1 and 1A).

Referring now to FIGS. 4 and 5, another embodiment of the poker button 10 of the present invention, hereinafter poker button 100, is disclosed. Poker button 100 is substantially the same as poker button 10, except that the poker button 100 is not used as a “dealer” button but rather as a “spinner” to be used by players to cover or otherwise protect their playing cards. For this reason, the same reference numbers used in describing the features of the poker button 10 will be used when describing the identical features of the poker button 100. The poker button 100 can be used by players as a paper weight to weigh down their cards and prevent them from being accidentally removed by the dealer. The advertising indicia 18 can include the name of a gaming establishment or other sponsor, perhaps as a give-away to poker players or for sale.

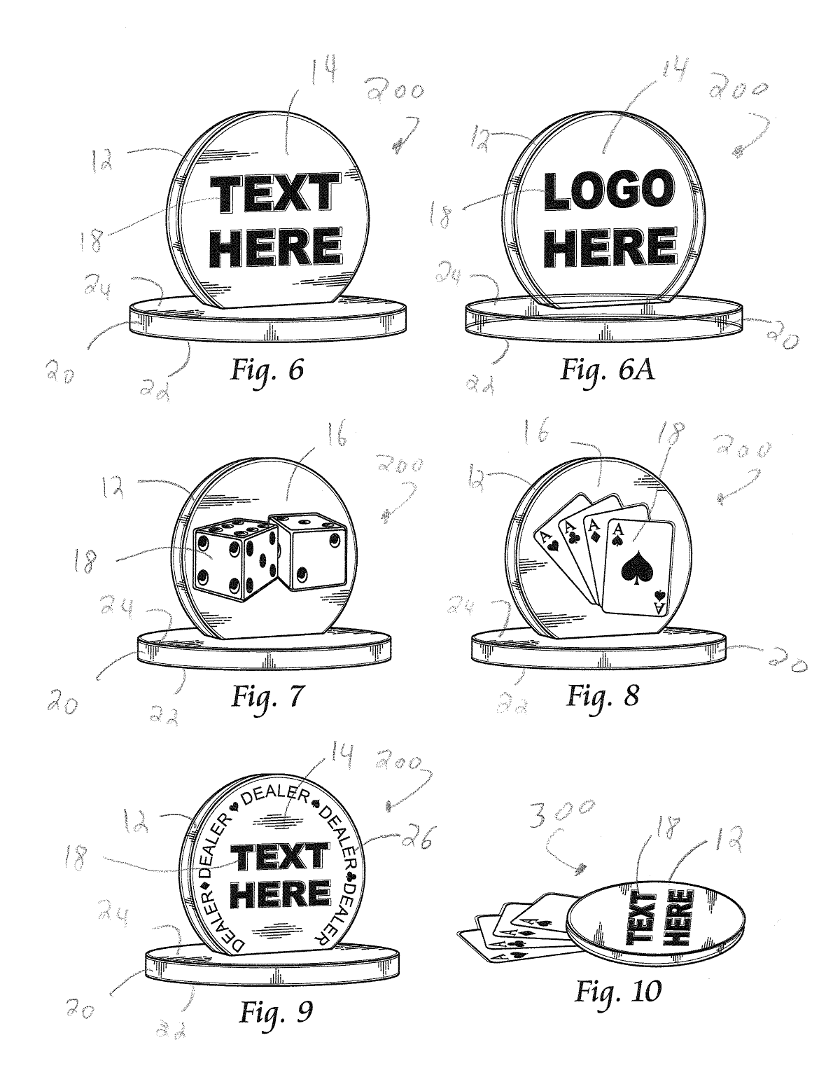

Referring now to FIGS. 6-9, another embodiment of the poker button 10 of the present invention, hereinafter poker button 200, is disclosed. Poker button 200 is substantially the same as poker button 10, except that poker button 200 further comprises a substantially flat pedestal 20. For this reason, the same reference numbers used in describing the features of the poker button 10 will be used when describing the identical features of the poker button 200. The poker button 200 comprises a substantially flat pedestal 20 having a bottom surface 22 and a top surface 24. The top surface 24 of the pedestal 20 is coupled substantially perpendicular to the button 12 so that the button 12 is substantially perpendicular to a plane of a table when the bottom surface 22 of the pedestal is resting on the table. The button 12 comprises advertising indicia 18 located on at least one of the front surface 14 and the back surface 16 of the button 12 so that the advertising indicia 18 can be visible to players and bystanders at a poker table. Preferably, the poker button 12 and the pedestal 20 are substantially the same size, although it should be clearly understood that substantial benefit could be derived from an alternative embodiment of the present invention in which the pedestal 20 is larger or smaller than the poker button 12, so long as the pedestal 20 is capable of resting on a substantially flat surface and supporting the poker button 12 substantially perpendicular thereto. Preferably, an outer portion of the poker button 12 is substantially flat and coupled to the top surface 24 of the pedestal 20, although it should be clearly understood that substantial benefit could be derived from an alternative embodiment of the present invention in which the top surface 24 of the pedestal defines a recessed portion dimensioned to receive a portion of the poker button 12 or in which the poker button 12 is secured by some type of an adhesive (such as, but not limited to, an epoxy) to the top surface 24 of the pedestal 20.

Referring now to FIG. 10, another embodiment of the poker button 10 of the present invention, hereinafter poker button 300, is disclosed. Poker button 300 is substantially the same as poker button 10, except that the poker button 300 is not used as a “dealer” button but rather as a card protector to be used by players to cover or otherwise protect their playing cards. For this reason, the same reference numbers used in describing the features of the poker button 10 will be used when describing the identical features of the poker button 300.

Referring now to FIGS. 1, 1A and 9, advertising indicia 18 may also be located on a perimeter 26 of either the front surface 14 or the back surface 16 of the button 12. The advertising indicia 18 may be an advertisement for the gaming establishment, a poker sponsor or other advertiser, or merely indicate that the poker button 12 is a dealer button.

The poker button 12 may be substantially opaque (see FIGS. 1, 2, 3, 4, 5, 6, 7, 8, 9 and 10) or substantially translucent (see FIGS. 1A and 6A). In addition, the pedestal 20 may be substantially opaque (see FIGS. 6, 7, 8 and 9) or substantially translucent (see FIG. 6A).

### Statement of Operation

In one embodiment of the present invention, a method of advertising is disclosed wherein a poker button 12 is provided for use as a marker in a poker game. The poker button 12 may be used as a dealer button, a spinner, a card protector, a “kill” button or for some other poker related purpose. The poker button 12 is marked with advertising indicia 18 on at least one of the front surface 14 and the back surface 16 of the button 12 so that poker players are capable of viewing the advertising indicia 18 when playing or watching a poker game.

In another embodiment, the poker button 12 is coupled to a top surface 24 of a pedestal 20 so that the advertising indicia 18 can be displayed perpendicular to a table surface when the bottom surface 22 of the pedestal 20 is resting on a table.

While the invention has been particularly shown and described with reference to preferred embodiments thereof, it will be understood by those skilled in the art that the foregoing and other changes in form and details may be made therein without departing from the spirit and scope of the invention. For example, while in the preferred embodiment the poker buttons 10, 100 and 200 comprise advertising indicia 18 for display preferably in a gaming establishment such as a casino, it should be clearly understood that substantial benefit could be derived from customizing buttons 12 to include advertising indicia 18 for private use, such as at home poker games, where players can use customized buttons 12 to advertise their own names, favorite sports teams or some other element of personal interest.

I claim:

1. A poker button comprising;
a button having a front surface and a back surface;
advertising indicia located on at least one of said front surface and said back surface of said button; and
a substantially flat pedestal having a bottom surface and a top surface, said top surface of said pedestal coupled substantially perpendicular to said button so that said button being substantially perpendicular to a plane of a table when said bottom surface of said pedestal resting on said table.

2. The poker button of claim 1 wherein said advertising indicia being located on a perimeter of at least one of said front surface and said back surface of said button.

3. The poker button of claim 1 wherein said advertising indicia being located on a substantially center area of at least one of said front surface and said back surface of said button.

4. The poker button of claim 1 wherein said button being one of substantially translucent and substantially opaque.

5. The poker button of claim 1 wherein said pedestal and said button having a size substantially the same.

6. The poker button of claim 1 wherein an outer circumference of said button having a substantially flat portion coupled to said top surface of said pedestal.

7. The poker button of claim 1 wherein said pedestal being one of substantially translucent and substantially opaque.

8. A method of advertising comprising, in combination, the steps of:
providing a poker button for use as a marker in a poker game, said poker button having a front surface and a back surface; and
marking said button with advertising indicia on at least one of said front surface and said back surface of said button so that poker players are capable of viewing said advertising indicia when playing a poker game.

9. The method of claim 8 further comprising the steps of:
providing a substantially flat pedestal having a bottom surface and a top surface; and
coupling said top surface of said pedestal substantially perpendicular to said button so that said advertising indicia located on at least one of said front surface and said back surface of said button being substantially perpendicular to a plane of a table when said bottom surface of said pedestal resting on said table.

10. The method of claim 8 further comprising the step of marking a perimeter of at least one of said front surface and said back surface of said button with said advertising indicia.

11. The poker button of claim 8 further comprising the step of marking a substantially center area of at least one of said front surface and said back surface of said button with said advertising indicia.

12. The poker button of claim 8 wherein said button being one of substantially translucent and substantially opaque.

13. The poker button of claim 9 wherein said pedestal and said button having a size substantially the same.

14. The poker button of claim 9 further comprising the step of coupling a substantially flat portion of an outer circumference of said button to said top surface of said pedestal.

15. The poker button of claim 9 wherein said pedestal being one of substantially translucent and substantially opaque.
